(19) United States
(12) Patent Application Publication
(10) Pub. No.: US 2026/0194187 A1
(43) Pub. Date: Jul. 9, 2026

(54) SYSTEM AND METHOD FOR CRYO-COMPRESSED HYDROGEN PRODUCTION AND UTILIZATION

(71) Applicant: Verne Inc., San Francisco, CA (US)

(72) Inventors: David E. Jaramillo, San Francisco, CA (US); Julio Moreno-Blanco, Leon (MX)

(73) Assignee: Verne Inc., San Francisco, CA (US)

(21) Appl. No.: 19/128,742

(22) PCT Filed: Nov. 22, 2023
(86) PCT No.: PCT/US2023/080841

§ 371 Date: May 9, 2025

Related U.S. Application Data
(60) Provisional application No. 63/427,814, filed on Nov. 23, 2022.

(51) Int. Cl. F17C 5/06

(52) U.S. Cl. CPC F17C 5/06; F17C 2221/012; F17C 2223/0161; F17C 2223/036; F17C 2227/0157; F17C 2227/0339; F17C 2265/06

(57) ABSTRACT

A system and method for managing a cryo-compressed state of hydrogen fuel that includes a compressor with a gaseous hydrogen input and a compressor output; a cooling system, wherein the compressor output is coupled to the cooling system for transfer of hydrogen fuel in a compressed state to the cooling system; and a storage system wherein the storage system stores hydrogen fuel in a cryo-compressed state resulting from cooling of the hydrogen fuel by the cooling system.

### CROSS-REFERENCE TO RELATED APPLICATIONS

This application claims the benefit of U.S. Provisional Application No. 63/427,814, filed on 23 Nov. 2022, which is incorporated in its entirety by this reference.

### TECHNICAL FIELD

This invention relates generally to the field of cryo-compressed hydrogen, and more specifically to a new and useful system and method for the production, management, and utilization of cryo-compressed hydrogen.

### BACKGROUND OF THE INVENTION

Cryo-compressed hydrogen (CcH₂) storage is a combination of the attributes of compressed gaseous hydrogen (GH₂) storage and liquid hydrogen (LH₂) storage. One of the disadvantages of compressed hydrogen storage is that large volumes and high pressures are required to store sufficient energy for desired applications. Some of the main disadvantages of liquid hydrogen storage are boil-off losses, high operational complexity, high-costs, and a centralized supply chain. Cryo-compressed hydrogen storage serves to address some of these challenges to enable a solution that combines the availability and usability of GH₂ with the high densities of LH₂. In many instances, the densities of CcH₂ are even higher than that of LH₂.

Current methods to produce cryo-compressed hydrogen first require the production of liquid hydrogen. This is a very expensive step which typically requires around ⅓ of the lower heating value of hydrogen (33.3 kWh/kg). Additionally, liquefaction systems are very energy inefficient at scales relevant to emerging use cases for the developing hydrogen economy, such as for trucking stations. Following liquefaction, the hydrogen is converted into CcH₂ using a cryogenic high-pressure pump. This method represents a roundabout way for CcH₂ production. Such an approach is energy inefficient, depends on LH₂ supply, and necessitates the use of expensive cryogenic high-pressure pumps.

When cooling hydrogen, it is important to consider the nuclear spin state of hydrogen as it has important implications for thermal management. Hydrogen molecules (H₂), have two nuclear spin states: an ortho configuration and a para configuration. The para configuration is the thermodynamically favored state but at room temperature, hydrogen molecules preferentially populate the ortho-state: bulk hydrogen comprises approximately 75% ortho-H₂ and 25% para-H₂. This is known as “normal” hydrogen. As hydrogen is cooled, the para-H₂ population increases, reaching 99.7% at 20 K and 1 bar. Conversion of ortho hydrogen to para hydrogen is a very exothermic reaction. At 20 K, 708 kJ/kg is released during the conversion, which is greater than the enthalpy of vaporization of hydrogen (445 kJ/kg). Typically, this reaction requires a catalyst, as it is a very slow natural conversion, occurring on the order of days. Once hydrogen has reached its equilibrium concentration at cryogenic temperatures, and the system is subsequently warmed up, para-to-ortho conversion is possible. This is an endothermic reaction which can effectively absorb heat flux and thereby extend time before a venting event occurs (i.e., increase hydrogen “dormancy”).

As cryo-compressed hydrogen has started to advance from the laboratory to market entry, there is a greater need to enhance cryo-compressed hydrogen production, management, and utilization. A more efficient system and method is needed to meet the needs of emerging industries. This invention provides such a new and useful system and method.

### BRIEF DESCRIPTION OF DRAWINGS

FIG. 1 is a schematic for an example system.

FIG. 2 is a pressure-temperature diagram that shows a comparison of an existing pathway to form cryo-compressed hydrogen shown in a dashed line compared to a pathway shown in a bold solid line of the systems and methods described herein.

FIGS. 3A-3B are schematic representations of system variations with sequential processing flows.

FIGS. 4A-4C are schematic representations of system variations used for producing and maintaining cryo-compressed hydrogen.

FIGS. 5A and 5B are schematic representations of system variations receiving compressed hydrogen from an outside source.

FIG. 6 is a schematic representation of producing cryo-compressed hydrogen for immediate dispensing.

FIG. 7 is a schematic representation of a system variation that dynamically customizes ortho-para concentrations for dispensing.

FIG. 8 is a schematic representation of a system variation that selectively dispenses from one or more storage tanks of a storage system based on desired dormancy.

FIGS. 9A-9C are schematic representations of system variations with various cooling system configurations.

FIGS. 10A and 10B are dispensing system variations.

FIG. 11 is a schematic for an example cooling system that comprises a heat exchange pathway containing a catalyst.

FIG. 12 is a flowchart representation of an example method for preparing, maintaining, and utilizing cryo-compressed hydrogen.

FIG. 13 is a flowchart representation of an example method for preparing cryo-compressed hydrogen.

FIG. 14 is a flowchart representation of an example method for maintaining cryo-compressed hydrogen.

FIG. 15 is a flowchart representation of an example method for dispensing cryo-compressed hydrogen.

FIG. 16 is a directed flowchart representation of an example method for preparing and maintaining cryo-compressed hydrogen.

FIG. 17 is a schematic diagram of a method using temperature in evaluating processing of hydrogen fuel for satisfying an ortho concentration level.

FIG. 18 is a flowchart of an example method using temperature sensing for producing cryo-compressed hydrogen of a targeted ortho concentration.

FIG. 19 is a chart showing the relative efficiencies for different methods of producing cryo-compressed hydrogen.

FIG. 20 is a graph showing the dormancy for cryo-compressed hydrogen for different ortho-hydrogen concentrations.

FIG. 21 is an exemplary system architecture that may be used in implementing the system and/or method.

### DETAILED DESCRIPTION OF THE EMBODIMENTS

The following description of the embodiments of the invention is not intended to limit the invention to these embodiments but rather to enable a person skilled in the art to make and use this invention.

### 1. Overview

Systems and methods for cryo-compressed hydrogen (e.g., CcH₂) production, management and/or utilization leverages a process by which gaseous hydrogen may be converted to cryo-compressed hydrogen for refueling purposes. The systems and methods may function to enable enhanced production, storage and/or dispensing of cryo-compressed hydrogen. Different variations of the systems and methods may enable different enhancements and/or combinations of enhancements.

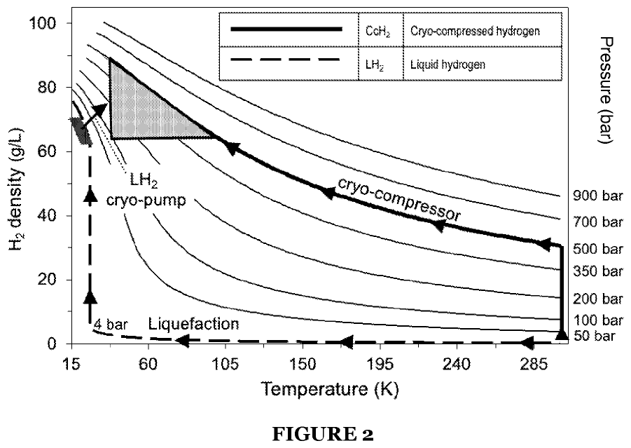

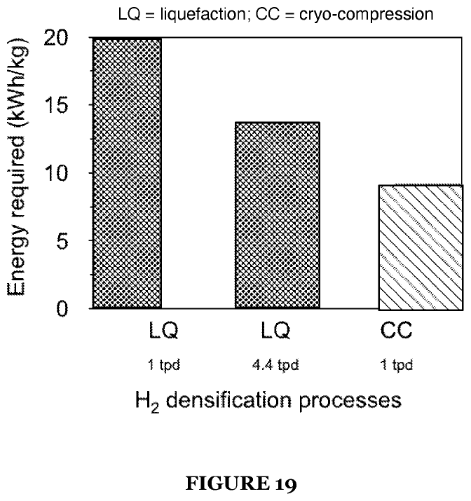

As one potential enhancement, the systems and methods may enable a novel approach for conversion of gaseous hydrogen into cryo-compressed hydrogen. The systems and methods, in some variations can use a conversion process that is not reliant on liquefaction processes. As shown in FIG. 2, cryo-compressed hydrogen can be produced by the system via a cryo-compressor route (solid path) which altogether avoids liquefaction (dashed path). While the systems and methods may be used in connection with liquid hydrogen infrastructure, the systems and methods may decouple high-density hydrogen fuel from liquid hydrogen and its supply chain. By avoiding liquefaction, high-density hydrogen can be obtained with great energy savings, as shown in FIG. 19, even at small scales. In particular, as decentralized, gaseous hydrogen production rolls out across the world, the cryo-compressor route can represent the lowest cost approach to densify and move hydrogen around at small scales.

The system may be implemented at any scale, for production, storage, and dispensation of cryo-compressed hydrogen and represents a lower cost system for high-density hydrogen management. That is, the system may be implemented for large scales (e.g., greater than five tons of cryo-compressed hydrogen per day), small scales (e.g., less than one ton of cryo-compressed hydrogen per day), or at scales in between for many different use cases.

As another potential enhancement, the systems and methods may enable storage and/or dispensing of cryo-compressed hydrogen tuned for different dormancy levels. The ratio of para-H₂ to ortho-H₂ supplied to a storage vessel may determine dormancy.

The systems and methods described herein may make use of novel and surprising design approaches to leverage endothermic reaction resulting from conversion between para to ortho states of hydrogen molecules (H₂). For cryo-compressed hydrogen, the nuclear spin state of hydrogen may be leveraged for thermal management by the systems and methods. Hydrogen molecules (H₂) have two nuclear spin states: an ortho configuration and a para configuration. The para configuration is the thermodynamically favored state but at room temperature, hydrogen molecules populate both states, and bulk hydrogen comprises approximately 75% ortho-H₂ and 25% para-H₂. This is known as “normal” hydrogen. As hydrogen is cooled, the para-H₂ population increases, reaching 99.7% at 20 K and 1 bar. Conversion of ortho hydrogen to para hydrogen is a very exothermic reaction. At 20 K, 708 kJ/kg is released during the conversion, which is greater than the enthalpy of vaporization of hydrogen (445 kJ/kg). However, the reaction is relatively slow, and catalysts are typical implemented. To avoid substantial boil-off once the hydrogen is stored as a liquid, the conversion may be implemented during the liquefaction steps. Once the system is subsequently warmed up during storage, the equilibrium concentration of para decreases slightly, and over sufficiently long time periods (e.g. hours) para-to-ortho conversion is possible. This is an endothermic reaction which can effectively absorb heat flux and thereby extend time before a venting event occurs (i.e., increase hydrogen “dormancy”). For liquid hydrogen, the possible equilibrium population change is minimum, so this phenomena has limited utility. However, if the hydrogen is stored as cryo-compressed hydrogen, the temperature and pressures ranges can be achieved are greater than in liquid hydrogen storage systems. In other words, cryo-compressed hydrogen storage systems sample a much greater equilibrium concentration of ortho-hydrogen relative to liquid hydrogen storage systems. Liquid hydrogen storage systems typically have a working temperature range of 20-33 K, while cryo-compressed hydrogen systems can range from 13-100 K, or warmer. Due to this wide range of equilibrium concentrations and the associated endothermicity, this phenomenon may be important to control and leverage for cryo-compressed hydrogen systems.

In some variations, a high-pressure heat exchanger may be used to fine-tune the desired ortho concentration for a given end-use. Additionally, or alternatively, a catalyst may be used to similarly fine-tune the desired ortho concentration. In one example, in one exemplary variation, a system or method may convert gaseous hydrogen at around 300 K and around 75% ortho concentration to cryo-compressed hydrogen and 50-75% ortho concentration, which can extend the dormancy of the fuel by multiple days. In some variations, such conversion parameters may be pre-configured into the design of the system. In other variations, a system and method may employ monitoring of the ortho and/or para concentration in a buffer CcH₂ storage vessel and operate the heat exchange system and/or catalyst system accordingly.

As another potential enhancement, the systems and methods may incorporate variations that enable controllable dormancy of dispensed fuel. Some input or condition can be monitored and used to adjust the para/ortho concentrations for fuel that is dispensed. In this way, the systems and methods of some variations may have controllable dormancy of the fuel it supplies to other equipment.

The systems and methods may additionally enable various energy efficient solutions. As a more energy efficient and capital efficient solution (e.g., compared to processes converting gaseous to liquid hydrogen), the systems and methods may more feasibly implemented at different scales. For example, the systems and methods may be applicable for small scale deployments of the system (e.g., supporting production and/or supplying 200 kg of fuel per day) as well as larger scale systems (e.g., supporting production and/or supplying 5,000 kg of fuel per day).

The systems and methods may include different variations that function to enable calibrated or tuned dormancy by controlling or otherwise managing ortho-para concentrations in the cryo-compressed hydrogen.

The systems and methods may generally be used for producing cryo-compressed hydrogen from hydrogen gas; maintaining the cryo-compressed hydrogen; and/or dispensing the cryo-compressed hydrogen. Producing cryo-compressed hydrogen may occur at a compressor and cooling system that function at moderate to high pressures (e.g. 200-700 bar). Maintaining and managing the cryo-compressed hydrogen may occur at a buffer storage system that has managed ortho-para ratios for improved length of storage (i.e. dormancy). Dispensing the cryo-compressed hydrogen may occur at a dispenser specialized for the use case, wherein the type of end-use utilization (short term or long term use) may be leveraged for improved dispensing.

The systems and methods may be implemented in any general use case of cryo-compressed hydrogen. The systems and methods may be particularly useful in applications where there is a need for high-density hydrogen and there is either no liquid hydrogen supply or the cost and boil-off challenges of liquid hydrogen are prohibitive for the desired application.

The systems and methods may also be particularly useful when a compact and deployable high-density hydrogen solution is needed. The systems and methods may be used in making a compact and energy efficient cryo-compressor for small scale production (200-2000 kg/day) with energy efficiency of 5-15 kWh/kg, in contrast to liquefaction which has efficiency of 15-25 kWh/kg at these scales.

The systems and methods may be particularly useful for use-cases where there is a need for building out infrastructure for refueling equipment operating using cryo-compressed hydrogen. Cryo-compressed storage and dispensing systems may be used to fuel equipment such as trucks/cars, planes, ships, trains, industrial machinery (e.g., mining machines/vehicles, farming equipment, etc.), and/or other machines.

Depending on the end use of the fuel, the systems and methods may be adjusted for the particular application. For example, the systems and methods may be used as part of refueling station for trucks where little to no dormancy is desired. In other cases, the systems and methods may be used for equipment where they may be some delay before the fuel is used so some calibrated amount of dormancy is desired to preserve utility of the fuel, such as in farming applications.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

One potential benefit of the systems and methods is that it provides an energy efficient way of producing cryo-compressed hydrogen. Current methods produce cryo-compressed hydrogen via liquid hydrogen, which at scales of 200-2,000 kg/day requires around 15-25 kWh per kg of hydrogen liquefied. At just 1 tonne per day, the cryo-compression process is >25% more energy efficient than a much larger (much still small for liquefaction plants) liquid plant of around 5 tonnes per day. In general, at these scales, cryo-compression enables 50% energy savings relative to liquefaction.

While for liquefaction, it is necessary to go down to 20 K, and provide enough energy to undergo the phase transition from gaseous to liquid hydrogen, in cryo-compression, the phase transition is avoided, and the phase is always gaseous. Furthermore, there is no need to go down to such low temperatures, like 20 K, to reach high densities, and instead, a combination of cooling and pressurizing, can enable densities comparable to that of liquid hydrogen storage systems at 6 bar, such as 55 g/L. In addition, as there is no liquid formation, boil-off is altogether eliminated and instead there is simply gaseous venting, which occurs less readily. This leads to an overall higher energy efficiency.

Additionally, through the direct production, the system and method may enable efficient deployment. That is, small scale production of cryo-compressed hydrogen becomes a viably energy efficient way of production. This is because the cryo-compression process is inherently more energy efficient so that at small scales, relevant to early deployment or transportation use cases, it is the most economical solution for high-density hydrogen.

By being economical at small scales, cryo-compressors can be deployed wherever cheap renewable energy exists to couple with green hydrogen production. This enables a decentralized high-density green hydrogen infrastructure.

Another benefit is that a cryo-compressor enables compact, high-density hydrogen loops for cycling tests. A critical test for many hydrogen components, such as storage vessels, is to carry out cycling experiments, for example for 10,000 cycles. This can be prohibitively expensive for liquid hydrogen given the high energy demand needed. Alternatively, for a cryo-compressor setup, high-density hydrogen can be produced, utilized, and re-enter the cryo-compressor. An energy-efficient closed-loop system for high-density hydrogen is possible, enabling cycling tests. Furthermore, as the cryo-compressor can be compact, this can be implemented in hydrogen test centers. The alternative for high-density hydrogen testing is to have an on-site liquefier, which is very likely not economical for most test centers.

The system and method also provides the benefit of efficient cryo-compressed storage. By leveraging the ortho-para conversion of hydrogen, the system and method provide a means for both short term and long-term storage of cryo-compressed hydrogen.

Additionally, the system and method provides the potential benefit of efficient dispensing of cryo-compressed dependent on the type of utilization. Through leveraging the ortho-para conversion of hydrogen, the system and method may efficiently dispense hydrogen dependent on direct use, or use over extended periods. In other words, the ortho-para ratio can be tuned depending on the end-use application. There is a different preferred ortho-para distribution whether the truck driver plans to fuel and drive immediately, or park the truck for multiple days, for example.

### 2. System

The system functions to produce, store, manage, and/or dispense cryo-compressed hydrogen. In some variations, the system can enable producing cryo-compressed hydrogen directly from gaseous hydrogen. Additionally or alternatively, some system variations may enable storing cryo-compressed hydrogen in different hydrogen configurations (e.g., with targeted ortho-para concentrations). Additionally, some system variations may manage or control the ortho and para concentrations there enabling improved long and short-term storage and customization of such storage capabilities. As another additional or alternative capability, some system variations may dispense cryo-compressed hydrogen as “intelligently” dependent on its utilization.

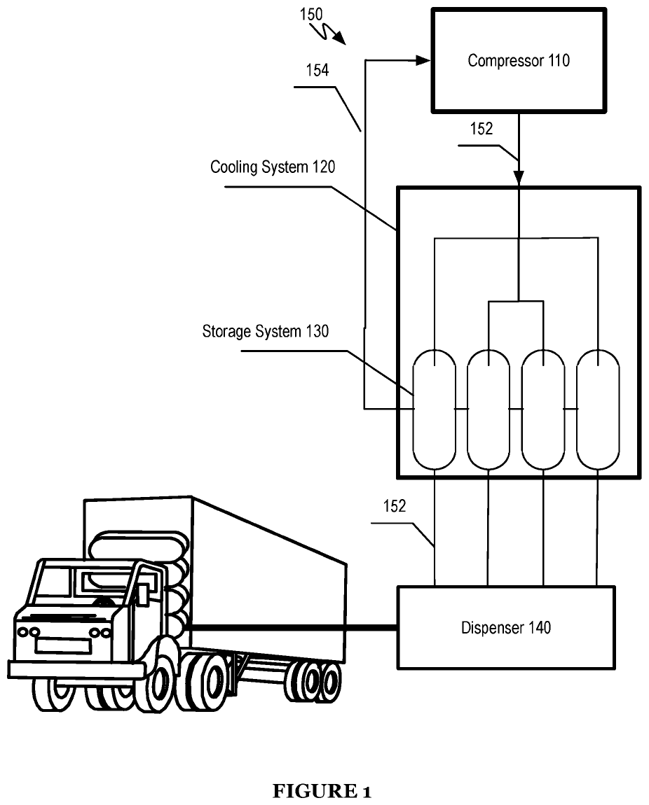

As shown in FIG. 1, one variation of the system for cryo-compressed hydrogen production, management, and/or utilization may include: a compressor 110 to pressurize hydrogen; a cooling system 120 to cool high-pressure hydrogen; a storage system 130 with at least one storage tank/vessel that stores cryo-compressed hydrogen; and a dispensing system 140. The system additionally includes a fuel processing network 150 comprised of conduit channels 152 interconnecting the components of the system such as the compressor 110, the cooling system 120, the storage system 130, the dispensing system 140, and/or other components or sub-components described herein.

As shown in FIG. 2, cryo-compressed hydrogen can be produced by the system via a cryo-compressor route (bold solid path) which altogether avoids liquefaction (dashed path). By avoiding liquefaction, high-density hydrogen can be obtained with great energy savings, as shown in FIG. 19, even at small scales. The system may be implemented at any scale, for production, storage, and dispensation of cryo-compressed hydrogen and represents a lower cost system for high-density hydrogen management. That is, the system may be implemented for large scales (e.g., greater than five tons of cryo-compressed hydrogen per day), small scales (e.g., less than one ton of cryo-compressed hydrogen per day), or at scales in between for many different use cases.

The system may be configured into various configurations and/or sub-combinations of the components depending on the intended use case and desired functionality.

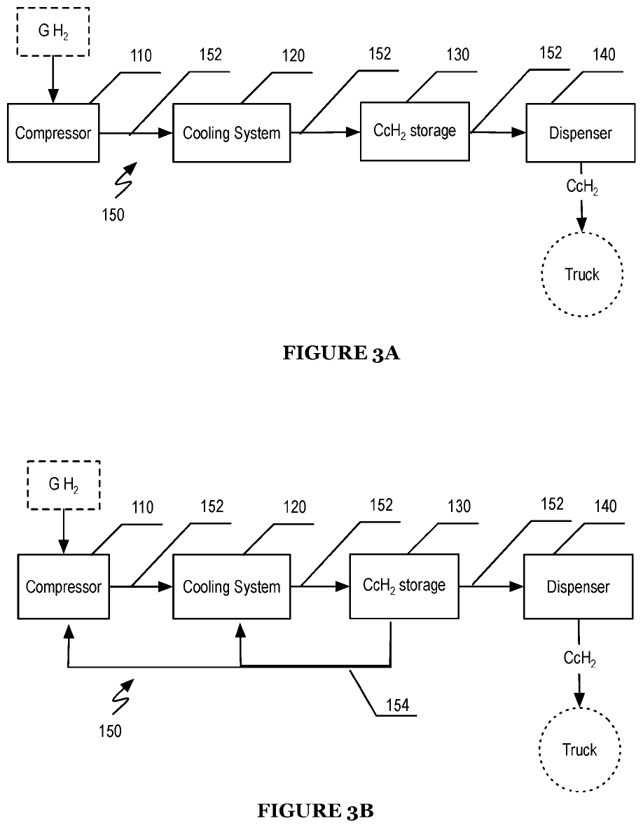

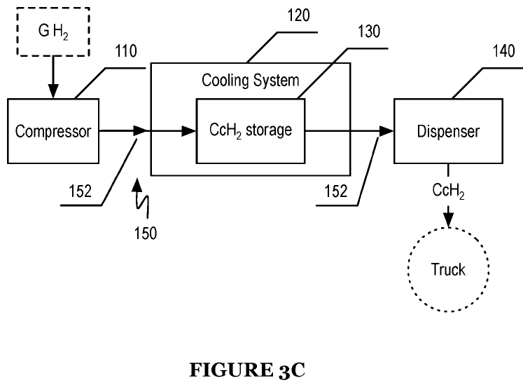

In one variation, the system may be configured for a sequential processing flow through the different components. Accordingly, as shown in FIG. 3A, a system variation may include a compressor 110, a cooling system 120, a storage system 130, a dispensing system 140, and a fuel processing network 150 comprised of conduit channels 152, where the fuel processing network is configured to have a directed processing flow sequence of the compressor 110, the cooling system 120, the storage system 130, and the dispensing system 140.

More specifically, a system for managing a cryo-compressed state of hydrogen fuel hydrogen can include a compressor 110 with a hydrogen input (e.g., a gaseous hydrogen input) and a compressor output (i.e., a compressed hydrogen output); a cooling system 120, wherein the compressor output is coupled (e.g., fluidically coupled) to the cooling system for transfer of hydrogen fuel in a compressed state to the cooling system 120; a storage system 130, wherein the storage system 130 stores hydrogen fuel in a cryo-compressed state resulting from cooling from the cooling system. The system will generally also include a fuel processing network 150 that includes interconnecting conduit channels that connect at least the compressor, cooling system, and storage tank in a sequential processing flow.

The system may additionally include a dispensing system 140 or connect with an external dispensing system. The dispensing system couples to the storage system 130 and more specifically an output of the storage system (i.e., a storage system output). In variations with a dispensing system 140, the interconnecting conduit channels of the fuel processing network 150 preferably connects at least the compressor 110, cooling system 120, storage tank 130, and dispensing system 140 in a sequential processing flow. In some variations, there may be no direct dispensing of cryo-compressed hydrogen fuel. For example, the storage vessel or tank from the storage system 130 may be removed and used as fuel storage vessel for another system. In other words, such a storage system can be swapped out. The cooling system 120 can have a cooling system input and a cooling system output, wherein the cooling system input, in some variations is compressed hydrogen fuel, in other words hydrogen fuel in a compressed state (e.g., 200-700 bar).

In some variations, the system may employ alternative and/or dynamic fuel processing paths. As one application, the system may enable reprocessing of fuel. This may be used to adjust the conditions of the fuel such as by altering the ortho-para concentrations of stored cryo-compressed hydrogen. As another application, the system may reprocess vented gaseous hydrogen so that it can be returned to a usable state. This may reduce fuel waste for the system. As shown in FIG. 3B, such a system variation may include a compressor 110, a cooling system 120, a storage system 130, a dispensing system 140, and a fuel processing network 150 comprised of conduit channels 152, where the fuel processing network is configured to have a directed processing flow sequence of the compressor 110, the cooling system 120, the storage system 130, and the dispensing system 140 as well as at least one reprocessing sub-network 154. The sub-network may contain pressure regulation capabilities to ensure the re-processed hydrogen has the required pressure to re-enter the cooling system. The reprocessing sub-network may be controlled to dynamically direct the hydrogen fuel to an appropriate component depending on state of the hydrogen.

In one variation, the cooling system 120 may be configured to integrate or include the storage system 130. Accordingly, as shown in FIG. 3C, a system variation may include a compressor 110, a cooling system 120 that includes an integrated storage system 130, a dispensing system 140, and a fuel processing network 150. As one example, the storage system may contain a liquid nitrogen jacket, and with sufficient thermal mass, the storage system ensures the compressed hydrogen is cooled and maintained to liquid nitrogen temperatures, close to 77 K.

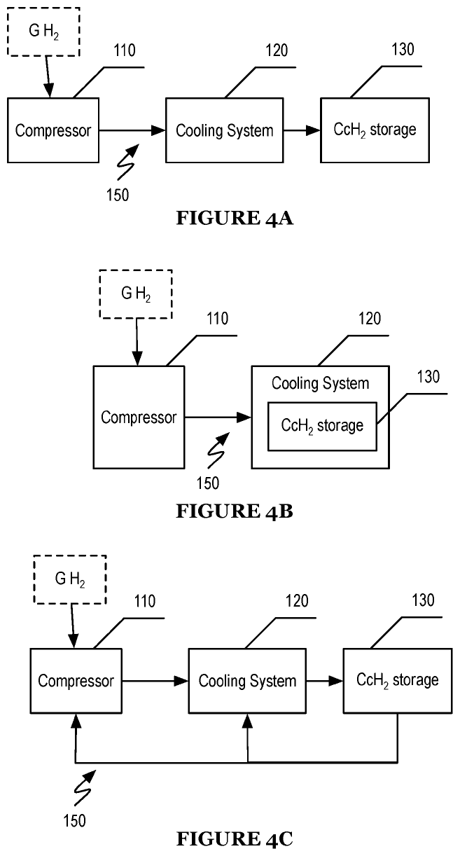

While the dispensing system 140 may be applicable to many situations, in some applications a dispensing system 140 may not be applicable or an external dispensing system may be used. Accordingly, as shown in FIG. 4A, a system variation may include a compressor 110, a cooling system 120, a storage system 130, and a fuel processing network 150 comprised of conduit channels 152, where the fuel processing network is configured to have a directed processing flow sequence of the compressor 110, the cooling system 120, and the storage system 130. Such a system variation may incorporate other variations of the system described herein. For example, such a variation could include variations with a cooling system 120 with an integrated storage system 130 as shown in FIG. 4B or with a reprocessing sub-network 154 as shown in FIG. 4C.

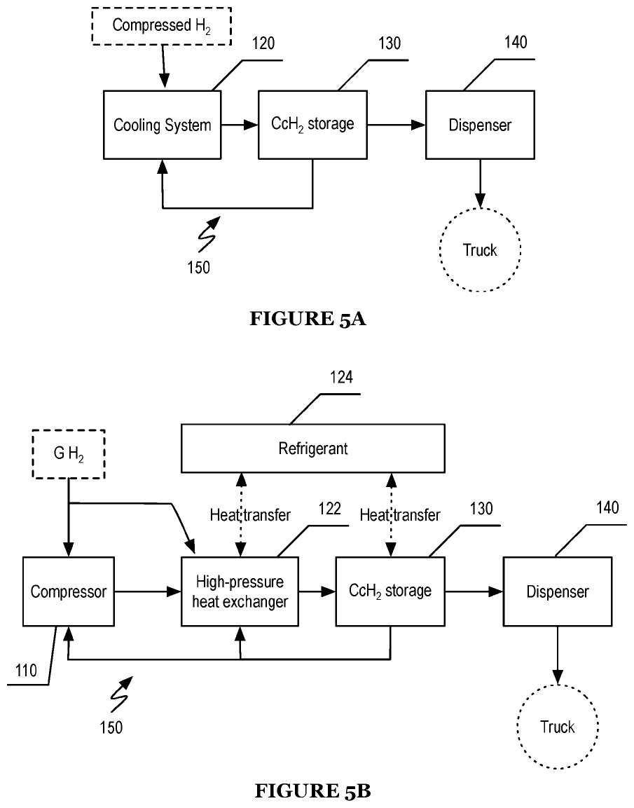

Herein, the system is primarily described as including a compressor 110 that functions to pressurize gaseous hydrogen. In some variations, pressurized gaseous hydrogen may be supplied from some external source. As such, as shown in FIG. 5A, the system may include a cooling system 120, a storage system 130, and a dispensing system 140 and a fuel processing network 150. High-pressure gaseous hydrogen may be delivered directly to the cooling system 120. In some variations, the system may have a flexible design such that normal gaseous hydrogen or high-pressure gaseous hydrogen may be supplied. In the case of high-pressure gaseous hydrogen, then a valve can redirect the high-pressure gaseous hydrogen directly to the cooling system 120; and in the case the gaseous hydrogen is not pressurized, directing the gaseous hydrogen to the compressor system 110 as shown in FIG. 5B.

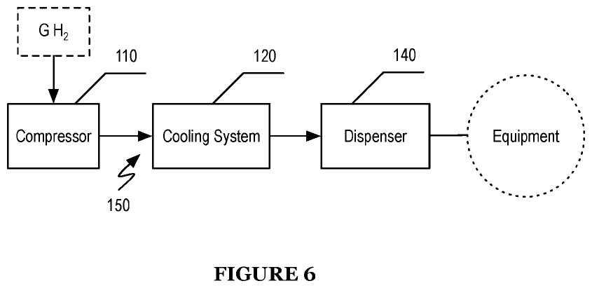

While the storage system 130 may be applicable to many situations, in some applications a storage vessel that functions as a buffer or temporary vessel for storage of cryo-compressed hydrogen, may not be applicable. Produced cryo-compressed hydrogen may be directly dispensed. Accordingly, as shown in FIG. 6, a system variation may include a compressor 110, a cooling system 120, a dispensing system 140, and a fuel processing network 150 comprised of conduit channels 152, where the fuel processing network is configured to have a directed processing flow sequence of the compressor 110, the cooling system 120, and the dispensing system 140.

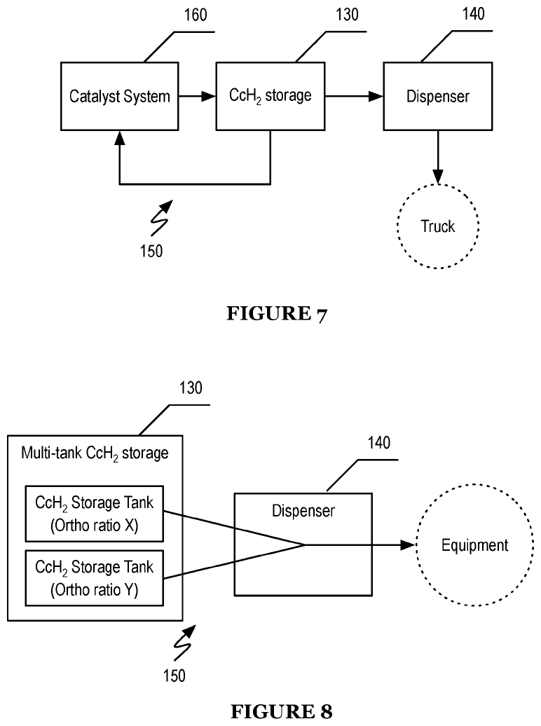

In some variations, the system is implemented to enable dispensing of cryo-compressed hydrogen with calibrated ortho-para concentrations. While this capability may similarly be applied in other variations, one system variation may be reduced to a system that includes components for controlling ortho-para concentrations for dispensing. In one variation, as shown in FIG. 7 the system may include a catalyst system 160, a storage vessel 130, a dispensing system 140, and a fuel processing network 150 that incorporates a reprocessing sub-network for recycling hydrogen fuel for adjustments to the ortho-para concentration. In another approach, as shown in FIG. 8, a multi-tank storage system 130 may be used where the dispensing system 140 can either selectively dispense from different tanks and/or mix cryo-compressed hydrogen with different ortho/para concentrations to calibrate ortho/para concentrations of dispensed cryo-compressed hydrogen.

While these different variations of the system may be possible, herein the system is primarily described from the perspective of a fully integrated system that assists in producing cryo-compressed hydrogen, temporarily storing the cryo-compressed hydrogen, and then dispensing the cryo-compressed hydrogen as shown in FIG. 3A. Any of the component and system variations may be adapted to or integrated with the other variations described herein.

In some variations, the system may further include a hydrogen production apparatus; i.e., a component that produces gaseous hydrogen from liquid water and transfers it to the compressor 110. In one of these variations, the hydrogen production apparatus comprises an electrolysis apparatus connected to a water source, wherein the electrolysis apparatus extracts gaseous hydrogen from the water source.

In some variations, however, a system focused on production of cryo-compressed hydrogen may include a compressor 110, a cooling system 120, a storage system 130, and a fuel processing network 150 comprised of conduit channels 152 interconnecting the components of the system such as the compressor 110, the cooling system 120, the storage system 130 and/or other components or sub-components described herein.

The compressor 110 functions to compress hydrogen gas. The compressor increases the pressure of a supplied hydrogen fuel, which will generally be in a gaseous form. As mentioned, in some variations, compressed hydrogen may alternatively be supplied directly. The compressor 110 may be designed to function with an inlet pressure of approximately ambient pressure to 20 bar and an outlet pressure of approximately 200-875 bar but preferably closer to 500 bar. Accordingly, the compressor 110 may compress a gaseous hydrogen input to 200-875 bar. In some variations, the inlet pressure may be higher (e.g., 80 bar), depending on whether the hydrogen is produced on-site, and on the method of hydrogen production and delivery. Accordingly, the compressor 110 may have an input of gaseous hydrogen 20-80 bar, though other inputs may alternatively be used. In other variations, the inlet pressure may be much higher (e.g. 200 to 350 bar if it is being trucked in to the cryo-compressor site as GH₂).

The compressor 110 may be of any type of pressure system that can apply pressure to achieve the desired pressure range of a hydrogen fuel output. Examples of compressor types include: positive displacement compressors (e.g., reciprocating compressors, ionic liquid piston compressors, rotary screw compressors, rotary vane compressors, rolling piston compressors, diaphragm compressors) and dynamic compressors (e.g., air bubble compressors, centrifugal compressors, mixed-flow compressors). In many implementations, the system requires the compressor 110 to function in a high dynamic range (e.g., ~0-500 bar). For this reason, in some variations the system may include multiple compressors 110 wherein each compressor functions in some improved efficiency range, thereby providing better efficiency for compressing hydrogen.

The cooling system 120 functions to cool or otherwise change the temperature of the hydrogen fuel to produce cryo-compressed hydrogen. Generally, the cooling system 120 may function to independently cool hydrogen and/or function in conjunction with other system components to cool hydrogen and/or maintain already cooled hydrogen. In particular, the cooling system 120 preferably cools hydrogen fuel in a compressed state (e.g., high-pressure hydrogen fuel). As such the cooling system can include an inlet or input for hydrogen fuel in a compressed state. The compressed hydrogen may in some variations originate from a compressor 110 (or more specifically a compressor output). The compressor output can be coupled to the cooling system for transfer of the hydrogen in the compressed state to the cooling system. In another variation, the cooling system 120 may have an inlet with connection to another source of high-pressure hydrogen.

The cooling system 120 in some preferred variations acts on or includes a sub-system that cools pressurized hydrogen fuel (supplied from the compressor 110). In one example, the cooling system 120 may function in conjunction with the compressor 110 to simultaneously cool hydrogen gas as it is being compressed. Additionally, the cooling system 120 may function to provide cooling to maintain cryo-compressed hydrogen, which in some variations includes integrating with the storage system 130 to cool stored cryo-compressed hydrogen. For example, the cooling system 120 may be incorporated with the storage system 130 such that the cooling system helps maintain the cryo-compressed hydrogen cold. In another example, the cooling system 120 may be incorporated with the dispensing system 140 to minimize heat loss during cryo-compressed hydrogen dispensement.

The cooling system 120 may implement any type of cooling mechanism. The cooling system 120 may be configured to cool within the appropriate thermodynamic conditions required to produce cryo-compressed hydrogen, as shown in FIG. 2; i.e., the cooling system must be able to operate in the appropriate temperature and pressure range. That is, the cooling system 120 must be able to cool hydrogen from the implemented ambient temperatures (e.g., room temperature, ~293-298 K) to the cryo-compressed hydrogen temperatures (~33-110 K); and designed to function at the required pressures and preferably 500 bar. Accordingly, the cooling system 110 may cool and/or maintain temperature of 33-110 K for compressed hydrogen at ~200-875 bar, thereby establishing hydrogen fuel in a cryo-compressed state (i.e., cryo-compressed hydrogen).

Accordingly, when the compressor 110 and the cooling system 120 are used in combination the compressor compresses a hydrogen fuel in a gaseous state to a compressed state with a pressure of 200-875 bar; and the cooling system cools the hydrogen fuel in the compressed state to 33-100K thereby establishing hydrogen fuel in a cryo-compressed state (i.e., cryo-compressed hydrogen).

As described above, the cooling system 120, may implement any general type of cooling/refrigeration that is compatible with the appropriate temperature and pressure ranges. These may be cyclic or non-cyclic types of refrigeration. For example, the cooling system 120 may implement: mechanical refrigeration, thermoelectric cooling, magnetic refrigeration, vapor-compression refrigeration, absorption refrigeration, adsorption refrigeration, heat, gas cycle, thermoacoustic refrigeration (e.g., pulse tube refrigerator), dilution refrigeration, and the like.

It can be noted that some of these types of refrigeration may have limited ranges of cooling and cooling efficiencies. For example, some forms of mechanical refrigeration and magnetic refrigeration work well near room temperature, but are somewhat inefficient below 0° C. On the other hand, thermoacoustic refrigeration and dilution refrigeration are much more efficient at temperatures on the order of 10 K. In many variations, the cooling system 120 may include multiple types of cooling refrigeration. For example, the cooling system 120 may include a magnetic refrigeration component intake that works in conjunction with the compressor 110, which cools ambient temperature hydrogen during compression, which is then then transferred to a cyclical vapor-compression refrigeration component (e.g., using liquid N₂), which then further cools the compressed hydrogen to the desired cryo-compressed temperatures. In the same manner, the cooling system 120 may use the same, or a different refrigeration component better optimized for cold temperature maintenance of the storage system 130. For example, the cooling system may further include a dilution refrigerant (i.e., 3He/4He) surrounding the storage system 130 to maintain its temperature.

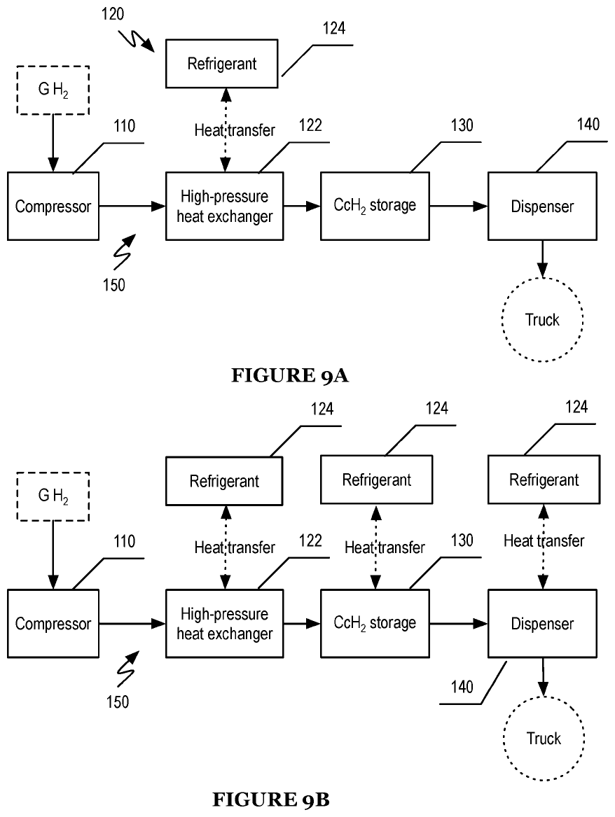

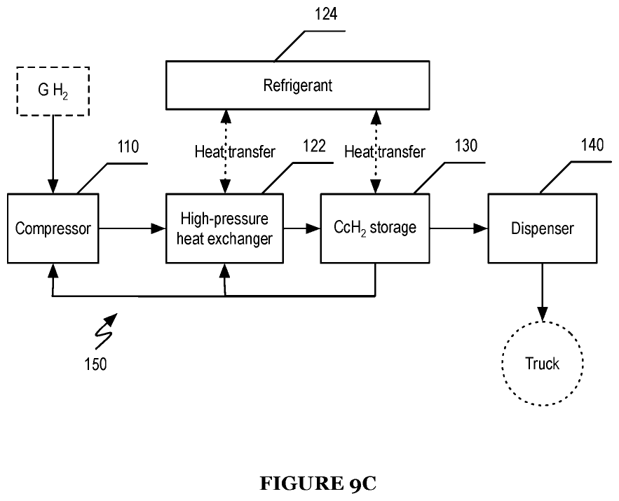

In one variation, the cooling system 120 includes a heat exchanger 122 and a refrigeration system 124, where the heat exchanger is thermally coupled to a refrigeration system 124, and where hydrogen in compressed state is passed through the heat exchanger as shown in FIG. 9A.

The heat exchanger functions to enable heat transfer from the hydrogen out of the system (typically first to the implemented refrigerant), thereby cooling the hydrogen. The heat exchanger may be situated on, around, and through any other system component, thereby enabling heat transfer with that component. The heater exchanger may be a diffusion bonded heat exchanger. Alternatively, the heat exchanger may be an adhesion bonded heat exchanger.

The heat exchanger may be any general type of heat exchanger. Examples include: shell and tube heat exchanger, double pipe heat exchanger, plate heat exchanger, plate and shell heat exchanger, adiabatic wheel heat exchanger, finned tube heat exchanger, pillow plate heat exchanger.

In many variations, the heat exchanger comprises a parallel current flow heat exchanger (with, or counter-current). Alternatively, the heat exchanger may comprise a cross-current flow heat exchanger.

The heat exchanger must be able to meet the required life cycle under cryo-compressed hydrogen operating conditions. The combination of hydrogen embrittlement, high pressures, and cryogenic temperatures can represent a challenge. The microdiffusion bonded heat exchanger, with an alloy like Stainless Steel 316L, is a preferred embodiment.

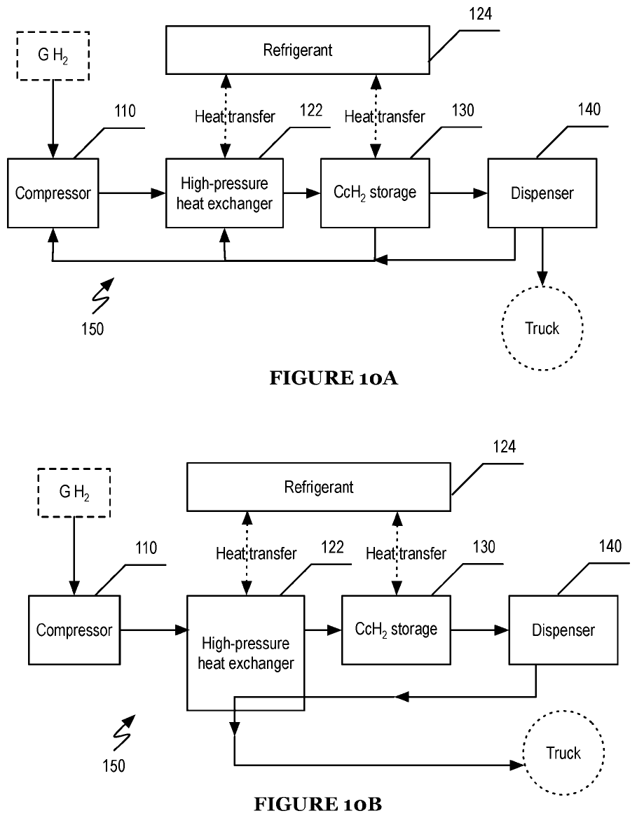

The heat exchanger 122 in one variation is integrated in series between the compressor 110 and the storage system 130, where the heat exchanger 122 is a distinct heat exchanger as shown in FIG. 9A. The fuel processing network 150 can interconnect the components such that hydrogen fuel (ambient gaseous hydrogen) is supplied to the compressor that outputs compressed hydrogen, which transfers through an interconnecting conduit channel to the heat exchanger 122 of the cooling system 120, and which then transfers hydrogen fuel that is now compressed and cooled to become cryo-compressed hydrogen to the storage system 130. In one embodiment, the same heat exchanger, having sufficient thermal mass, can be used to also cool down hydrogen as it is being dispensed. As shown in FIG. 10B, hydrogen fuel may be cycled through the heat exchanger 122 during dispensing. This may function to share a heat exchanger resource for production of fuel as well as dispensing.

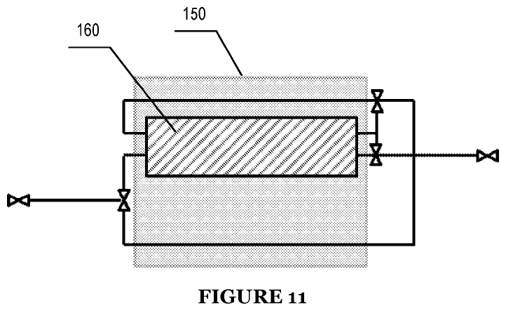

In some variations, the heat exchanger may include a catalyst 160. In other words, the catalyst 160 is integrated within the heat exchanger. The catalyst may be used to alter ortho/para concentrations within the hydrogen fuel. The catalyst 160 may be incorporated into the heat exchanger as shown in FIG. 11 such that as fuel is cooled by the heat exchanger 122, and the ortho/para concentrations may also be altered through exposure to the catalyst.

Additionally or alternatively, the heat exchanger 122 may include or be integrated within a reprocessing sub-network of the fuel processing network 150. This may be used so that hydrogen fuel may be recycled back through the heat exchanger.

In one variation, the reprocessing sub-network may be integrated with the heat exchanger 122 to process hydrogen fuel over multiple cycles through the heat exchanger to iteratively cool the hydrogen fuel to a targeted temperature. In this variation, a reprocessing sub-network may be used to selectively reprocess hydrogen by the cooling system 120 or to transfer hydrogen fuel to a connected component (e.g., the storage system 130).

Accordingly, the system can include a reprocessing sub-network within the heat exchanger, as shown in FIG. 11, that includes a first selectable conduit channel that transfers hydrogen fuel in the cryo-compressed state to the storage vessel and a second selectable conduit channel that recirculates the hydrogen fuel through the heat exchanger. The first and second selectable conduit channels may be subsequent to an integrated catalyst 160 and/or an output of the cooling system 120. Selection of the two selectable conduit channels may be based on sensed para ortho concentrations. In such a variation, this reprocessing sub-network may be configured such that hydrogen fuel may be selectively exposed to the catalyst or not when passing through the heat exchanger 122 as shown in FIG. 11.

The refrigeration system 124 functions to actively cool and extract heat energy from a component of the system and thereby hydrogen fuel of the component.

In some variations, the refrigeration system 124 may be thermally coupled to the heat exchanger 122, the storage system 130, the dispensing system 140, the fuel processing network 150, or some other suitable component of the system.

In one variation, the cooling system 120 includes a refrigeration system 124 that is thermally coupled to the storage system 130, this may be independent of any heat exchanger or other cooling system used to cool compressed hydrogen. As shown in FIG. 9B, a distinct refrigeration system may be integrated with a heat exchanger 122, the storage system 130, and the dispensing system 140. In some variations, a refrigeration system 124 used by a heat exchanger 122 may be shared with other components as shown in FIG. 9C.

In one variation, liquid N₂ can be utilized. Once LN₂ has gasified, it enters the refrigeration loop and is re-liquified. This can also be combined with sacrificial LN₂. In another embodiment, similar refrigerant loops using in liquid natural gas, such as propane and ethylene, can also be implemented.

The storage system 130 functions as a buffer or temporary storage solution for processed and conditions cryo-compressed hydrogen. The storage system 130 include one, or more, tanks, receptacles, or other suitable vessels enabled to store cryo-compressed hydrogen. Hydrogen fuel is preferably supplied as input that has been pressurized and cooled to a pressure and temperate state of cryo-compressed hydrogen.

The storage system 130 may comprise one, or more, tanks/receptacles enabled to hold high pressure hydrogen. Additionally, the tanks may be sufficiently insulated such that cryo-compressed hydrogen held within the tanks is maintained at relatively constant temperature. Additionally or alternatively, some, or all tanks of the storage system 130 may have minimal, or no, insulation but are contained within the cooling system 120, such that the cooling system provides additional cooling and/or insulation for the tanks. In some variations, the tanks of the cooling system 120 may be multi-layered insulated storage vessels for enhanced cryo-compressed hydrogen as described in PCT Application with Pub. No. WO2023/183946, filed on 26 Mar. 2024, titled “SYSTEM AND OPERATING METHOD FOR ENHANCED DORMANCY IN CRYO-COMPRESSED HYDROGEN STORAGE VESSELS”, which is hereby incorporated in its entirety by this reference.

In some variations, the storage system 130 may be a multi-tank storage system, wherein the storage system 130 includes a plurality of tanks for cryo-compressed hydrogen storage. Dependent on implementation, these tanks may or may not be interconnected.

In one variation, different tanks from a multi-tank storage system may store cryo-compressed hydrogen of different states. In particular, the multi-tank storage system may store cryo-compressed hydrogen of different ortho-para concentrations, which functions to store different cryo-compressed hydrogen for different amounts of dormancy (e.g., short-term and long-term storage). Accordingly, a first storage tank and a second storage tank of the plurality of storage tanks may store hydrogen of cryo-compressed hydrogen with differing ortho-para concentrations. The tanks preferably contain a specific population of ortho-hydrogen for specific end-use cases, such as immediate driving or immediate idling of a long-haul truck.

The system can preferably selectively process and generate the cryo-compressed hydrogen of a targeted state and then deliver it to a corresponding tank. Then, the system switches to processing and generating cryo-compressed hydrogen of a different state for another tank.

In such a variation, the fuel processing network 150 may include routing options to selectively direct produced cryo-compressed hydrogen to a select tank based on ortho-para concentrations of prepared cryo-compressed hydrogen. In a similar way, the fuel processing network 150 may include reprocessing sub-networks to reprocess hydrogen from the plurality of tanks.

Accordingly, a storage system 130 with a plurality of tanks may include long-term storage tanks and short-term storage tanks. The long-term storage tanks are used to store long-term use hydrogen and short-term storage tanks may be used to store short-term use hydrogen as described herein.

Long-term storage tanks may be characterized as tanks wherein the cryo-compressed hydrogen is converted or relaxed to a majority para state, its equilibrium state.

Long-term use hydrogen characterizes cryo-compressed hydrogen that has been converted to its equilibrium, or near-equilibrium, ortho-para concentration. The para to ortho conversion of hydrogen is an endothermic reaction. The stored cryo-compressed hydrogen storage can warm up over time due to controlled or uncontrolled heat flux through the storage system, which drives the equilibrium concentration towards ortho-hydrogen. Over time, this results in the endothermic para-to-ortho conversion, which absorbs energy and can thereby increase dormancy. Storage in these long-term systems can be used when dispensing demand decreases, such as during the weekend or a holiday, for trucking applications.

Short-term storage tanks may be characterized as tanks wherein the cryo-compressed hydrogen is produced relatively quickly (as compared to the ortho to para conversion) such that cryo-compressed hydrogen is closer to the initial hydrogen gas make up that is obtained (e.g., 75% ortho, 25% para at room temperature). Such a tank contains hydrogen outside of its thermodynamic equilibrium. In other words, the management and tank are design to trap the kinetic product.

Short-term use hydrogen is used herein to characterize cryo-compressed hydrogen closer to the initial hydrogen gas ortho-para concentration that was used to produce the cryo-compressed hydrogen. Typically, this is normal hydrogen, which comprises of 75% ortho-H₂. As the terms “short-term” and “long-term” are relatively analogous with respect to use and storage, as used herein, the terms may equally refer to storage or use without any loss of generality. That is, since short-term storage tanks are used for short-term cryo-compressed hydrogen use, “short-term” may equally refer to short-term use or short-term storage; and since long-term storage tanks are used for long-term cryo-compressed hydrogen use, “long-term” may equally refer to long-term use or long-term storage. As short-term and long-term refer to the extreme cases, different states between these short-term and long-term states can also be implemented as desired.

In some variations, some tanks of the storage system 130 may be designated for short-term storage (i.e., short-term tanks). In some variations, short-term tanks are insulated tanks situated outside of the cooling system 120. Alternatively, short-term tanks may be situated within the cooling system 120. These short-term tanks can be used when demand for dispensing is expected to be high, such as during a normal work week for trucking applications. Short tanks, and the strategies that enable short tanks, can be used to ensure certain buffer storage tanks are maintained at a certain pressure. This may be harnessed for cascade-like refueling, or simply to ensure that a given ΔP is always established for certain refueling protocols.

In some variations, some tanks of the storage system 130 may be designated for long-term storage (i.e., long-term tanks or buffer storage). In some variations, long-term tanks are insulated tanks situated outside of the cooling system 120. Alternatively, long-term tanks may be situated within the cooling system 120. Such long-term storage tanks may contain hydrogen that can be dispensed for long term storage use cases, such as a truck idling for multiple days.

In some variations, long-term tanks may be connected to the compressor 110 and/or the cooling system 120. In these variations, as the tank naturally heats and para to ortho conversion occurs, the content of the long-term tank is re-cycled through the compressor 110 and/or cooling system 120, thereby re-populating para-hydrogen and re-cooling the hydrogen. In another variation, long-term tanks may be situated within the cooling system 120. In this variation, the cooling system 120 may continuously cool the long-term tank thereby maintaining the equilibrium concentration and removing heat if any ortho to para conversion occurs. For example, in one implementation, a counter flow heat exchanger situated around the long-term tank may remove the heat generated. For better energy efficiency, this flow may be increased, decreased, and/or stopped dependent on the heat exchange needs. For example, the cooling flow can be tuned to match the heat flux into the tank and any exothermic conversions that occur.

In some variations, short-term tanks may convert to long-term tanks and vice-versa during regular operation. That is, during operation, tanks in the storage system 130 may change designation from short-term to long-term and vice-versa. For example, tanks may be initially designated as short-term. After the tank has been full for several days and is still relatively full, it may change designation to a long-term tank and the system may recycle or cool the stored cryo-compressed hydrogen to take into account the ortho to para conversion.

In another variation, a tank used to store long-term use hydrogen may be store hydrogen for some period of time close to the dormancy period of the long-erm use hydrogen such that the hydrogen may then be used as short-term use hydrogen.

The dispensing system functions to “dispense” out cryo-compressed hydrogen. The dispensing system 140 may be connected to the storage system 130 such that cryo-compressed hydrogen may be “pumped” from the storage system 130 to where it will be used. The dispensing system 140 may be at least partially designed for particular use cases. That is, the dispensing system 140 may include a nozzle, feed-tube, pump, etc., that is designed to connect to the use case. For example, for truck fueling, the dispensing system 140 may include a nozzle appropriate to connect with the truck fuel tank, thereby enabling fueling of the truck.

The dispensing system may contain another heat exchanger that leverages the already existing refrigeration system or may use the same heat exchanger that is used to cryo-compressed hydrogen.

In some situations, the dispensing system 140 or a truck (or receiving equipment) may vent hydrogen. The vented hydrogen can be returned via a dispensing reprocessing sub-network 154 back to the storage 130 or compressor 110 as shown in FIG. 10A.

In variations that include a plurality of storage system 130 tanks, the dispensing system 140, may access different types of storage tanks (e.g., long-term, short-term) thereby, providing different types of cryo-compressed hydrogen as a fuel source. Accordingly, the dispensing system selectively dispenses from a select storage tank of the plurality of storage tanks based on pressures and ortho-para concentration of the select storage tank. Dependent on implementation, the type of cryo-compressed hydrogen may be selected (e.g., by a user/customer) or automatically determined (e.g., by a control system provided with the type of available cryo-compressed hydrogen and/or the type of fuel utilization). By having options as it pertains to pressure and ortho-para concentration, many different types of refueling protocols and on-board use cases can be served, with a single refueling system.

In some variations, the system may not include a dispensing system 140 per se. In these variations, tanks within the storage system 130 may play multi-functional role. For example, tanks (or sets of tanks) within the storage system 130 may be the exact type that can be used by a vehicle. These tanks may fill a storage purpose while connected to the system, but may then be disconnected and attached to a vehicle as fuel canisters (e.g., fuel canisters on a truck). Once the fuel canister(s) are empty, they may then be offloaded and connected back into the storage system 130. This may be particularly useful for multi-layer insulation storage tanks.

The fuel processing network 150 functions as connecting conduits used to transfer hydrogen fuel through the various components of the system. The fuel processing network 150 can include a plurality of interconnecting conduit channels 152. These conduit channels may link or connect outputs and inputs of various components. For example, in system with a compressor 110, cooling system 120, storage system 130, and dispensing system 140, the conduit channels 152 may include: a compressed hydrogen conduit channel connecting an output of the compressor 110 to an input of the cooling system 120; a processed cryo-compressed hydrogen conduit channel connecting an output of the cooling system 120 to an input of the storage system 130; and a dispensing conduit channel connecting an output of the storage system 130 to the dispensing system 140.

The fuel processing network 150 is preferably directed such that hydrogen fuel may be transferred in one direction. In some variations, the fuel processing network 150 may include control valves, pressure regulation, or other control flow systems used to direct or otherwise manage flue of hydrogen fuel (depending on state of the hydrogen fuel). A control system may manage operation and control of the fuel processing network 150.

As discussed, some variations may include various reprocessing sub-network, which function as flow circuits within the fuel processing network 150 to recirculate and process hydrogen fuel in some way.

A reprocessing sub-network may be used to recool hydrogen, to alter ortho-para concentrations through exposure to a catalyst 160, and/or convert vented hydrogen back to cryo-compressed hydrogen. The resulting cryo-compressed hydrogen may then be restored in the storage system.

In one variation, the system includes a cooling system reprocessing sub-network. In some variations, this may be integrated directly within the cooling system 120. For example, a heat exchanger 122 may have a set of conduit channels with control valves that may be used to recycle hydrogen back through the cooler to cool the hydrogen. In other variations, the cooling system reprocessing sub-network may recycle hydrogen from the output of the cooling system 120 or from the storage system 130 back through the cooling system 120.

In another variation, the system includes a catalyst reprocessing sub-network. In this variation, a conduit channel may be used to return hydrogen fuel for further exposure to a catalyst, which functions to alter the ortho-para concentrations. The hydrogen fuel may be repeatedly exposed to the catalyst by cycling repeatedly back through the catalyst reprocessing subnetwork. In some variations, the catalyst reprocessing sub-network may be the same as a cooling system reprocessing sub-network.

In some variations, a control system may control a set of valves to redirect hydrogen flow through the fuel processing network. For example, control valves may be used to selectively determine if cryo-compressed hydrogen output from some component like a heat exchanger 122 should be reprocessed or if it should be directed to the storage system 130. In such a variation, the fuel processing network 150 may include a first selectable interconnection conduit channel from the heat exchanger system 122 connecting to the storage system 130 (or optionally the dispensing system 140 in some variations), and a second selectable interconnection conduit channel from the heat exchanger, returning hydrogen fuel back to a preceding component. In some variations, the preceding component can be the cooling system 120 with an integrated catalyst system or simply a standalone catalyst system.

In one variation, the system includes a vented hydrogen fuel reprocessing sub-network that transfers or cycles vented gaseous hydrogen fuel back from the storage vessel (or suitable component) to a compressor 110 so as to be reprocessed. In this variation, the storage system 130 may include a vent used to discharge gaseous hydrogen that can form. This functions to avoid waste and make the system more efficient. The storage system 130 may vent gaseous hydrogen that is collected and redirected via the vented hydrogen fuel reprocessing sub-network back to the compressor 110.

As discussed, some system variations may use a multi-tank storage system 140. In such a variation, the fuel processing network 150 may have selectable conduit channels to selectively fill different tanks. Alternatively, a fuel processing network may interconnect the tanks of the storage system 130 such that cryo-compressed hydrogen sequentially fills each tank.

In some variations, particularly variations that include long-term and short-term storage, the system may incorporate a catalyst that speeds up the ortho to para conversion of the cryo-compressed hydrogen. The catalyst 160 may include catalyst systems and/or processes such as described in PCT Application with Pub. No. WO2023/183946, which is incorporated by reference. In a variation that includes a catalyst, in one variation, the catalyst may be integrated such that hydrogen fuel may have the ortho-para concentrations altered to impact the dormancy of the cryo-compressed hydrogen fuel.

In some variations, the fuel processing network 150 may selectively route the hydrogen fuel to different components for differing processing. The fuel processing network 150 may include a selectable catalyst conduit channel and a non-catalyst conduit channel. In this way, the system may pass hydrogen fuel through the catalyst to increase dormancy but could also not pass the hydrogen fuel to the catalyst if the cryo-compressed hydrogen is for immediate use. In other variations, different catalysts or catalyst systems may be configured for differing exposure or impact of the catalyst may be used for different selectable conduit channels.

The catalyst may alternatively or additionally be integrated within some portion of the fuel processing network 150 or as a separate component. Examples of catalysts for the ortho to para conversion may include: a hydrogen catalyst (e.g., ortho-hydrogen has catalytic properties), molecular and material catalysts (e.g., hydrous ferric oxide, chromium oxides, nickel oxides), and/or field catalysts (e.g., paramagnets). Any other ortho to para catalysts may be incorporated as applicable. The catalyst may be incorporated into any and/or all system components and connectors where cryogenic hydrogen passes through. For example, the catalyst may be incorporated into the tubing 110 that is within the cooling system 120. As part of the FIG. 3 example, the catalyst may be in the flow tubes of the heat exchanger. In one implementation, as shown in FIG. 11, gaseous hydrogen may wrap back and travel through the catalyst embedded heat exchanger multiple times. In another implementation, the catalyst may be coated within the walls of a microdiffusion bonded heat exchanger.

As another variation, the catalyst may be in storage tanks designated for long-term storage. In the case of a multi-tank storage system 130, one or more tank may include a catalyst (possibly different types of catalysts) to calibrate stored hydrogen In one implementation of a catalyst within long-term storage tanks, the inner lining of the storage tank may be lined with the catalyst. In another implementation, a minimum amount of ortho-hydrogen may be kept (or pumped into) a long-term storage tank to promote the auto-catalytic effect of ortho-hydrogen.

In some variations, the system may include a sensing system to monitor state of the hydrogen fuel. The sensing system may include pressure sensors or detectors, temperature sensors, and/or sensors for monitoring ortho and/or para concentrations in hydrogen (e.g., a ortho-para monitoring system). The sensing system accordingly be output pressure parameters, temperature parameters, and/or ortho or para concentration parameters for hydrogen within the system and various points.

In one embodiment, a temperature-based sensor mechanism is used to infer the ortho-para concentration. A certain section of the sub-network may be calibrated to the temperature of the hydrogen following a known amount of ortho-conversion. This may be performed for a number of reference conditions. Each reference corresponds to a fixed amount of ortho hydrogen that was converted. This exothermicity increases the temperature of the hydrogen and its surrounding environment. In this way, with sufficient calibration under multiple reference cases, temperature sensor can be used to infer the ortho concentration.

In a similar variation, the temperatures of hydrogen fuel flowing through a heat exchanger under various conditions without a catalyst may be used for establishing reference temperatures. The various conditions could include a variety of hydrogen fuel flowrates and refrigerant flow rates during operation of the heat exchanger. This can establish a number of reference conditions for various operating conditions of the heat exchanger. When the heat exchanger is equipped with an integrated catalyst (such as in FIG. 11), temperature differences from the reference temperature of similar conditions (e.g., corresponding hydrogen fuel/refrigerant flow rates) can be associated with the exothermic reaction of ortho to para conversion. In other words, as the ortho-to-para conversion energy is known across relevant working conditions (e.g. in kJ/kg), if the flow rate is known, and if any possible temperature deviation is measured relative to a baseline case (e.g. no conversion), then the total conversion and conversion % of the flowing hydrogen can be assigned.

The system may additionally include a control system that functions to manage and control operation of the components and flow of hydrogen through and within the system. Control system can be configured to manage conditioning and production of hydrogen fuel and/or dispensing fuel from the dispensing system 140. The control system can additionally collect sensed parameters from the sensing system so as to determine how to alter operation of the system.

The control system may be used to selectably and dynamically direct flow of hydrogen fuel between different components for updated processing. This may be used to cool the hydrogen, or target some amount of catalyst exposure, to select or move hydrogen from different storage tanks of the storage system 130, and/or take other actions.

The control system may operate using pre-configured presets, based on user input, and/or sensed conditions.

As an example of pre-configured pre-sets, the control system may control the flow to target some temperature and/or amount of catalyst exposure. The operation of the system may be based on expected results of how processing of the hydrogen fuel will impact the state of the fuel. In one variation using temperature as an indicator for orthro to para conversion, a temperature sensor may measure the temperature and recycle hydrogen fuel through a catalyst equipped heat exchanger until a desired temperature difference is achieved, which would indicate a desired amount of ortho-to-para conversion has been achieved.

In some variations, the targeted properties may be conditional on other external factors such as time. For example, the system may operate with a configured setting for producing low dormancy during the work week, and then produce long dormancy over the weekend.

As an example of using user input, the control system may change operation in response to some user input. For example, the targeted level of dormancy may be determined based on some user input device. In one example, a user at 140 dispensing system 140 may select one of a set of possible dormancy levels depending on the desired amount of dormancy (e.g., long dormancy, short dormancy, no dormancy).

As an example of using sensed conditions, the control system may dynamically adjust exposure to a catalyst based on detected ortho-para conditions. In such a variation, the system may include a ortho-para monitoring system that collects ortho-para concentration data from the hydrogen fuel in the cryo-compressed state. In this variation, the fuel processing network 150 may include a reprocessing sub-network, where the control system can cycle hydrogen fuel back to the catalyst through the reprocessing sub-network based on the ortho-para concentration data.

### 3. Method

Methods for managing cryo-compressed hydrogen may function to facilitate production, storage, maintaining, and/or dispensing cryo-compressed hydrogen. Different variations of the method may facilitate different aspects of these capabilities.

In general, a method for managing cryo-compressed hydrogen can include compressing hydrogen fuel in a gaseous state (i.e., gaseous hydrogen) to a compressed state (i.e., compressed hydrogen), cooling the hydrogen in the compressed state to produce hydrogen fuel in a cryo-compressed state (i.e., cryo-compressed hydrogen), and storing the hydrogen fuel in the cryo-compressed state in a storage system. The method can additionally include dispensing the cryo-compressed hydrogen. The method can additionally include exposing the hydrogen fuel to a catalyst, which alters ortho-para concentration. The method can additionally include reprocessing the hydrogen fuel or a portion of the hydrogen fuel. Reprocessing may be used for converting vented gaseous hydrogen back to cryo-compressed hydrogen, recooling the hydrogen fuel, and/or altering the ortho-para concentrations.

The system is preferably implemented through a system such as the one described herein, but any suitable system may be used.

Accordingly, in some variations, the method may be performed with a system that passes hydrogen fuel through a heat exchanger with an integrated catalyst. In such a variation, the method may include cooling the hydrogen in a compressed state to produce hydrogen fuel in a cryo-compressed state, which comprises passing the hydrogen fuel in the compressed state through a heat exchanger and exposing the hydrogen fuel to a catalyst while within the heat exchanger, and storing the hydrogen fuel in a cryo-compressed state in a storage system, when the hydrogen fuel reaches a desired ortho concentration level.

This method could similarly include compressing hydrogen fuel in a gaseous state to a compressed state, but a source of compressed hydrogen fuel may alternatively be supplied from some other source. Similarly, this method may include dispensing the cryo-compressed hydrogen and/or other processes for maintaining the cryo-compressed hydrogen.

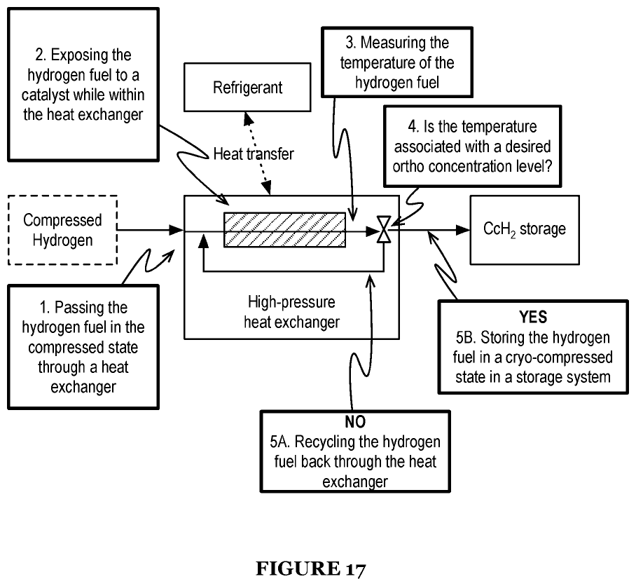

In some method variations, temperature sensing may be used to measure an amount of ortho to para conversion. Accordingly, as shown in FIG. 17, the method may more particularly include cooling the hydrogen in a compressed state to produce hydrogen fuel in a cryo-compressed state, which comprises: passing the hydrogen fuel in the compressed state through a heat exchanger, exposing the hydrogen fuel to a catalyst while within the heat exchanger, measuring the temperature of the hydrogen fuel, and based on the temperature associated with a desired ortho concentration level, recycling the hydrogen fuel back through the heat exchanger or storing the hydrogen fuel in a cryo-compressed state in a storage system. Recycling the hydrogen fuel back through the heat exchanger will pass the hydrogen fuel through the heat exchanger a subsequent time and re-exposing the hydrogen fuel to the catalyst a subsequent time. If the temperature indicates a desired ortho concentration is not satisfied, then the hydrogen fuel is recycled through the heat exchanger and the catalyst. If the temperature indicates a desired ortho concentration is satisfied, then the hydrogen fuel can be stored.

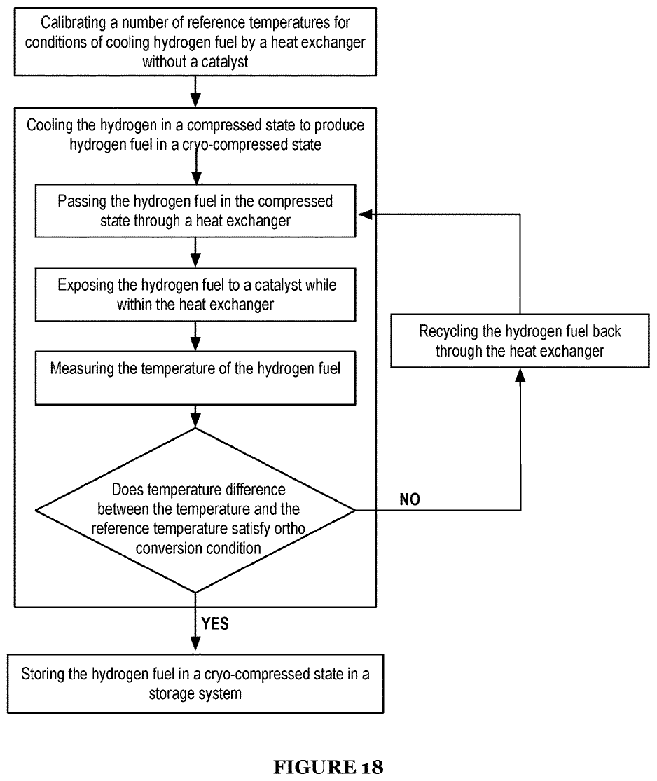

The temperature associated with a desired ortho concentration level is preferably based on a number of calibrated reference temperatures from conditions without ortho to para conversions (e.g., no exposure to a catalyst). Deviations of the temperature from a reference temperature can be associated with the exothermic reaction from ortho to para conversion initiated from exposure to a catalyst. Accordingly, as shown in FIG. 18, the method may more particularly include: calibrating a number of reference temperatures for conditions of cooling hydrogen fuel by a heat exchanger without a catalyst; cooling the hydrogen in a compressed state to produce hydrogen fuel in a cryo-compressed state, which comprises: passing the hydrogen fuel in the compressed state through a heat exchanger, exposing the hydrogen fuel to a catalyst while within the heat exchanger, measuring the temperature of the hydrogen fuel, and based on a temperature difference between the temperature and the reference temperature (e.g., a reference temperature from similar processing conditions of the heat exchanger without a catalyst), recycling the hydrogen fuel back through the heat exchanger or storing the hydrogen fuel in a cryo-compressed state in a storage system. The temperature difference is associated with an amount of ortho to para conversion and therefor may serve as an indicator of ortho concentration level.

Calibrating a number of reference temperatures for conditions of cooling hydrogen fuel by a heat exchanger can include for a number of conditions, measuring temperature of passing hydrogen fuel through the heat exchanger without a catalyst. A reference temperature may be used for calculating the temperature difference based on which corresponds to the current conditions. The number of conditions can include conditions for different hydrogen fuel flowrates and/or refrigerant flow rates. The temperature is preferably measured at the same location or region during calibration and during operation. In some variations, the temperature is measured at the end of the heat exchanger or near where the hydrogen fuel would exit the heat exchanger. In other words, measuring the temperature of the hydrogen fuel is measured after passing the hydrogen fuel through the heat exchanger.

In addition to using temperature as a proxy for measuring ortho concentration, temperature may also be used to detect when a catalyst has degraded. If processing of the hydrogen fuel through the heat exchanger deviates from expected results (e.g., some number of cycles or amount of flow typical for a certain targeted ortho conversion level), then triggering a catalyst degradation alert. For example, if it takes ten cycles through the heat exchanger to reach a targeted ortho concentration level (as indicated by temperature) when five is more normal, then it may mean the catalyst has degraded and a new catalyst should be installed soon.

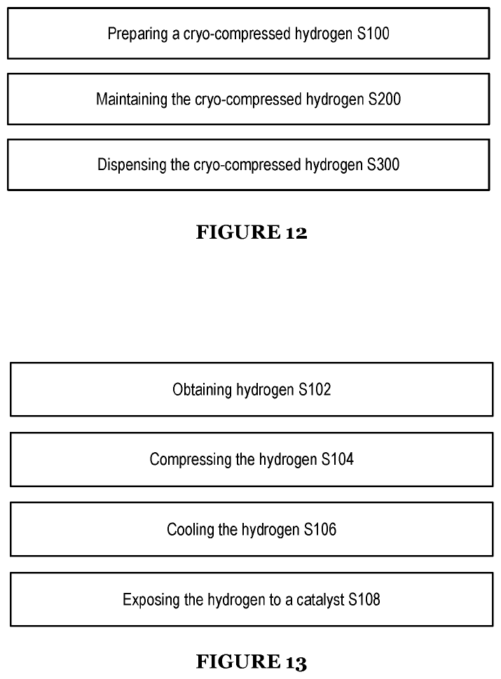

In general, the various processes may be characterized as preparing cryo-compressed hydrogen S100; maintaining the cryo-compressed hydrogen S200; and dispensing the cryo-compressed hydrogen as shown in FIG. 12. These processes may be implemented independently or in combination. The method is preferably implemented with a system such as described herein, but other suitable systems may alternatively be used.

In particular these cryo-compressed hydrogen processes may be characterized wherein: preparing cryo-compressed hydrogen S100, comprises obtaining hydrogen S102, compressing the hydrogen S104, thereby producing high pressure hydrogen, and cooling the high pressure hydrogen S106, thereby producing cryo-compressed hydrogen; maintaining the cryo-compressed hydrogen S200 comprises determining an ortho-hydrogen threshold S202, modifying the cryo-compressed hydrogen S204 to the ortho-hydrogen threshold, storing the cryo-compressed hydrogen S206 according to the ortho-hydrogen threshold, re-cooling the cryo-compressed hydrogen S208, and maintain the hydrogen at a given tank at a target pressure where application; and dispensing the cryo-compressed hydrogen S300, comprising optionally determining a type of cryo-compressed hydrogen utilization S302, comprising determining the appropriate ortho-hydrogen threshold for utilization. Such a method functions to produce cryo-compressed hydrogen, to store cryo-compressed hydrogen for short-term and long-term storage, and to provide different types of cryo-compressed hydrogen as a fuel source, dependent on the end-use utilization. Additionally, the method may leverage the quantity of short-term and long-term stored cryo-compressed hydrogen, and the demand for short-term use and long-term use cryo-compressed hydrogen to produce and provide the appropriate types of cryo-compressed hydrogen on a dynamic case-to-case basis. The method may be implemented with the system as described above but may be generally implemented with any appropriate system.

The method provides an over-arching supply chain for cryo-compressed hydrogen fuel starting from the acquisition of hydrogen to dispensation of cryo-compressed hydrogen fuel. That is, the method may be broken down into sub-groups of method steps that provide a specific implementation.

The method may be or include processes for production of cryo-compressed hydrogen. That is, a method for cryo-compressed hydrogen production, includes: preparing cryo-compressed hydrogen, comprising obtaining hydrogen, compressing the hydrogen, thereby producing high pressure hydrogen, and cooling the high pressure hydrogen, thereby producing cryo-compressed hydrogen; and maintaining the cryo-compressed hydrogen, comprising determining an ortho-hydrogen threshold, modifying the cryo-compressed hydrogen to the ortho-hydrogen threshold, storing the cryo-compressed hydrogen according to the ortho-hydrogen threshold, and if needed, re-cooling the cryo-compressed hydrogen. In some instance, maintaining a given tank at a given pressure can also be implemented. This method may function to produce and enhance the thermal properties of cryo-compressed hydrogen based on the desired storage duration and dispensing needs.

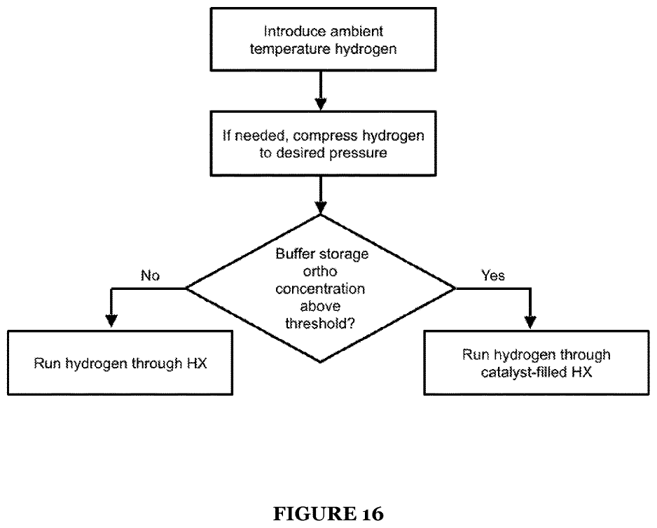

In some variations, production of cryo-compressed hydrogen may include variations to produce cryo-compressed hydrogen of a targeted ortho-para concentration. Such a variation may additionally include optionally exposing of the hydrogen fuel to a catalyst. In some variations, the catalyst may be integrated into a heat exchanger though a catalyst system may be integrated into other components where exposure to the catalyst is possible. As shown in FIG. 16, production of cryo-compressed hydrogen may have the option of exposing the hydrogen to a catalyst-filled heat exchanger (HX) or running the hydrogen through the heat exchanger without exposure to the catalyst.

The method may also be implemented as just a fuel dispensation method. That is, a method for demand-side cryo-compressed hydrogen utilization, includes: maintaining the cryo-compressed hydrogen, comprising determining an ortho-hydrogen threshold, modifying the cryo-compressed hydrogen to the ortho-hydrogen threshold, storing the cryo-compressed hydrogen according to the ortho-hydrogen threshold, and re-cooling the cryo-compressed hydrogen, as needed; and dispensing the cryo-compressed hydrogen, comprising determining a type of cryo-compressed hydrogen utilization, comprising determining the appropriate ortho-hydrogen threshold for utilization. This method may function to preferentially provide cryo-compressed hydrogen dependent on utilization need and flow rates required. In some instances, a cascade refueling protocol can be implemented. As such, various pressures can be maintained in the array of storage tanks.

Block S100, which includes preparing a cryo-compressed hydrogen functions to produce cryo-compressed hydrogen directly from gaseous hydrogen without initially producing liquid hydrogen (as shown in FIG. 2 with the bold solid path). As shown in FIG. 13, preparing a cryo-compressed hydrogen may include: obtaining hydrogen S102, compressing the hydrogen S104, and cooling the high-pressure hydrogen S106. As shown in FIG. 19, block S100 provides a more energy efficient method of producing cryo-compressed hydrogen as compared to initially producing liquid hydrogen. That is, directly preparing cryo-compressed hydrogen S100 enables efficient cryo-compressed hydrogen production at any scale.

Block S102, which includes obtaining hydrogen, functions in acquiring hydrogen for processing. Obtaining hydrogen S102, may occur from an external source. Alternatively, obtaining hydrogen S102 may comprise a production process (e.g., electrolysis), wherein hydrogen is extracted from a fluid (e.g., water). Obtaining hydrogen S102 typically comprises obtaining hydrogen gas at ambient or near ambient conditions. Alternatively, obtaining hydrogen S102 may comprise obtaining previously processed hydrogen (e.g., high pressure hydrogen, pre-cooled hydrogen, liquid hydrogen, etc.). Gaseous hydrogen can be channeled or otherwise supplied to a compressor system.

Block S104, which includes compressing the hydrogen, functions to produce high pressure hydrogen from the obtained hydrogen. Preferably, compressing the hydrogen S104 increases the pressure of the hydrogen to the desired cryo-compressed pressure (~200-700 bar). Compressing the hydrogen S104 may include utilizing a compressor for pressurizing the hydrogen. In some variations, compressing the hydrogen S104 may occur in conjunction with other hydrogen processing steps, such as cooling the hydrogen S106. For example, cooling power may be utilized from a cooling system, e.g., a cooling system from the system as described above.

Block S106, which includes cooling the hydrogen, functions to produce cooled hydrogen from the obtained hydrogen. Preferably, cooling the hydrogen S106 decreases the temperature of the hydrogen to the desired cryo-compressed temperature (~33-200 K). Cooling the hydrogen S106 may include utilizing a refrigeration system for cooling the hydrogen. In some variations, cooling the hydrogen S106 may occur in conjunction with other hydrogen processing steps, such as compressing the hydrogen S104. Cooling the hydrogen may include passing the hydrogen fuel through a heat exchanger or transferring it into a cryo-compressed storage unit which is maintained at cryogenic temperatures.

In some variations, preparing the cryo-compressed hydrogen can include exposing the hydrogen fuel to a catalyst S108. Exposing the hydrogen fuel to a catalyst may be used to alter the para and/or ortho concentrations. In one variation, the catalyst is integrated within the heat exchanger. Accordingly, in some variations cooling the hydrogen fuel (e.g., fuel in a compressed state) includes passing the hydrogen fuel in the compressed state through a heat exchanger and exposing the hydrogen fuel to a catalyst while within the heat exchanger. In one variation, the catalyst is integrated as one optional conduit channel running through the heat exchanger and where there is another optional conduit channel running through the heat exchanger without the catalyst (if no change to the ortho-para concentrations is desired). As indicated above, the method may re-expose the hydrogen to a catalyst until a desired ortho concentration level is achieved. In one variation, this level may be approximated or determined based on temperature measurements and how they differ from a reference temperature when no or little ortho to para conversion occurred.

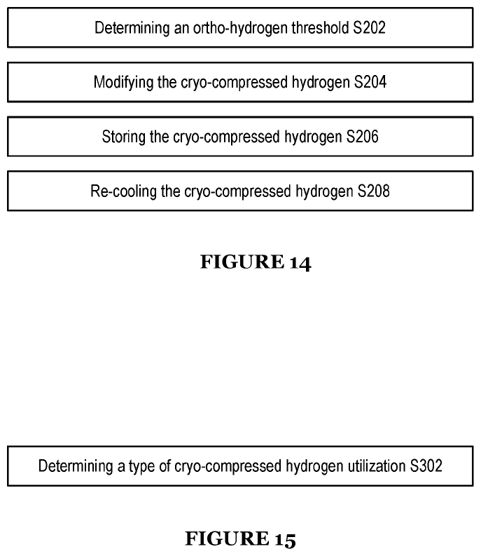

Block S200, which includes maintaining the cryo-compressed hydrogen, functions in storing the hydrogen. More specifically, block S200 may function in storing hydrogen in the desired hydrogen state and/or converting and then storing the hydrogen in the desired stored state. Maintaining the cryo-compressed hydrogen S200 includes: determining an ortho-hydrogen threshold S202 based on operating profile, modifying the cryo-compressed hydrogen S204 to the ortho-hydrogen threshold, storing the cryo-compressed hydrogen S206, and re-cooling the cryo-compressed hydrogen S208 as shown in FIG. 14.

Block S202, which includes determining an ortho-hydrogen threshold, functions to set a desired maximum ortho-hydrogen concentration for the cryo-compressed hydrogen based on the desired use case. Typically, ortho-hydrogen concentration can range from 75% to <0.3%. Normal hydrogen, which is 75% ortho hydrogen, is the typical hydrogen at the inlet of the process. The final ortho concentration, or the threshold value, depends on the desired use case.

At one extreme, is the use case of long-term storage (or extended use). For long term storage (or extended use), the ortho-hydrogen threshold may be at or near 15% ortho-hydrogen. Determining a long-term threshold may be based on use cases where cryo-compressed hydrogen will be dispensed for non-immediate usage (e.g., a fueled vehicle that won't be operated for several days), or slow usage (e.g., a fueled vehicle or data center uses cryo-compressed hydrogen in small amounts or intermittently) and the temperature of the hydrogen system. From a supply side “use case”, determining a long-term threshold may be based on having a sufficiently large amount of unused cryo-compressed hydrogen at hand. For example, cryo-compressed hydrogen has been produced (or is being produced), but no vehicles are present for fueling. As the hydrogen will not be immediately used, it may be designated as long-term storage.

The ortho-concentration can be used to control the pressurization rate of the system. As it is desirable for the system to contain an array of tank at various pressure levels, in order to meet various refueling protocols, the pressurization rate can be controlled by the ortho-concentration of the hydrogen that is introduced into the vessels. A cryo-compressed hydrogen storage vessel with high ortho-concentration will have a higher pressurization rate than a system with cryo-compressed hydrogen with equilibrium ortho hydrogen at a cryogenic temperature.

At the other extreme, is the use case of short-term storage (or immediate use). For short storage (or immediate use), the ortho-hydrogen threshold may be set at, or near, the ortho ambient concentrations (e.g., normal hydrogen concentrations with ~ 75% ortho-hydrogen). Determining a short-term threshold may be based on use cases where cryo-compressed hydrogen will be dispensed for immediate use. For example, this may include the use case in which cryo-compressed hydrogen is soon dispensed into a truck (e.g., the use case where the truck is going to drive immediately for a long-haul operation). From a supply-side use-case, determining a short-term threshold may be based on a shortage of hydrogen. For example, if the demand for hydrogen is sufficiently high, there may be no time for further processing of cryo-compressed hydrogen and vehicles may be directly fueled as cryo-compressed hydrogen is produced. In such examples, the hydrogen ortho-threshold can remain high, such as 75%. This further minimizes the energy cost of the process, as cooling power is not needed to compensate the exothermic ortho-to-para transition. As the hydrogen is going to be quickly used, there is low probably of the conversion occurring after being dispensed.

As the method functions to produce and distribute cryo-compressed hydrogen, determining an ortho-hydrogen threshold S202 may change, or be changed, dynamically. Determining an ortho-hydrogen threshold S202, may set any threshold between the two extreme use cases (short term and long term). As method operations occur over longer periods, the threshold may become better optimized dependent on the methods for cryo-compressed production and demand and types of utilization.

Additionally or alternatively, in variations where the method is implemented for systems with multiple storage containers, an ortho-hydrogen threshold may be set for each container. Determining an ortho-hydrogen threshold S202 may be set manually. Alternatively, the ortho-hydrogen threshold may be automatically set dependent on the method parameters, refueling demand, and the type of truck driving. These parameters may further include: amount of cryo-compressed hydrogen currently stored, current state for the cryo-compressed hydrogen in each storage container, total storage container capacity, rate of cryo-compressed production, demand for cryo-compressed hydrogen (quantity and type). Additional or alternative parameters may also be included in determining ortho-hydrogen threshold S202.

Block S204, which includes modifying the cryo-compressed hydrogen, functions to alter the state of the cryo-compressed hydrogen. In one variation, modifying the cryo-compressed hydrogen involves converting cryo-compressed hydrogen to the desired ortho-hydrogen threshold. That is, block S204 functions to reduce the ortho-hydrogen concentration of the cryo-compressed hydrogen, until it is below the threshold set by block S202. In many variations, this may be done in conjunction with re-cooling the cryo-compressed hydrogen and storing the hydrogen for a given duration. The cooling of hydrogen drives down the equilibrium ortho concentration and the specific storage duration enable the hydrogen to reach this equilibrium value. As the conversion itself heats the stored hydrogen, there is constant feedback between the current ortho-hydrogen concentration and whether additional re-cooling cycles are required. Additionally, modifying the cryo-compressed hydrogen S204 may occur in conjunction with preparing a cryo-compressed hydrogen S100.

In many variations, modifying the cryo-compressed hydrogen S204 includes incorporating a catalyst. Incorporating catalyst functions to improve reaction kinetics, thereby enabling faster ortho to para conversion. A catalyst may be particularly important in use cases where demand for long-term storage cryo-compressed hydrogen is high. This method can involve running the hydrogen through a catalyst-filled heat exchanger, such as that depicted in FIG. 11. Additionally or alternatively, particularly when demand is not so high, block S204 may not take any real action, as ortho to para conversion occurs naturally over slower time scales (e.g., over 10-20 days), or perhaps the threshold ortho value is that of normal hydrogen.

Block S206, which includes storing the cryo-compressed hydrogen, functions to store the cryo-compressed hydrogen at, or below, the determined ortho-hydrogen concentration. Storing the cryo-compressed hydrogen preferably stores the cryo-compressed hydrogen in containers able to hold and sufficiently insulate the cryo-compressed hydrogen (i.e., mid to low temperatures and high pressures). In many variations, dependent on the ortho-concentration, this storage may be in specific containers allocated for short-term or long-term storage, or somewhere in between. Generally, the lower the ortho-concentration, the longer the term of storage.

In some variations, the method may include variations of selectively transferring hydrogen to one of a set of storage vessels of a storage system. The cryo-compressed hydrogen may be stored into a storage vessel based on the ortho-hydrogen concentration, such that at least two different storage vessels in the storage system may have differing ortho concentrations. In this way, the method involves establishing a cryo-compressed hydrogen buffer array with known and different ortho-concentrations and pressures, to enable tailored fuel for various use cases and fueling protocols. A dispensing system may selectively engage with at least one of the set of storage vessels based on a desired ortho-concentration (or dormancy). In some cases, the different cryo-compressed hydrogen fuel with differing ortho-concentrations within the storage vessels may be mixed or combined to adjust ortho-concentrations across the storge system and/or when dispensing.

Block S208, which includes re-cooling the cryo-compressed hydrogen functions to remove the heat of conversion and potentially any external heat introduced into the system as needed to maintain the ortho-threshold value. Re-cooling the cryo-compressed hydrogen may incorporate any desired refrigeration method. Re-cooling the cryo-compressed hydrogen can also involve running the hydrogen through a catalyst-filled heat exchanger.

As another option, maintaining the cryo-compressed hydrogen S200 may include venting gaseous hydrogen from the storages system and recycling the gaseous hydrogen to a compressor for compressing and cooling the hydrogen back to a cryo-compressed state.

Block S300, which includes dispensing the cryo-compressed hydrogen functions to provide the cryo-compressed hydrogen for use. Block S300 may be specific for the implemented use case, with significant variations on what it is dispensed to (e.g., truck fuel, airplane fuel, data center energy supply, etc.) and general trends in how the fuel has been used or expected to be used (e.g., quantity, rate of use, etc.).

In some variations, dispensing the cryo-compressed hydrogen may additionally include cooling the hydrogen fuel in a cryo-compressed state during dispensing. In one particular variation, the cooling of the hydrogen fuel during dispensing may include cycling the hydrogen fuel back through a heat exchanger during dispensing as shown in FIG. 10B. Accordingly, the method may include dispensing the hydrogen in the cryo-compressed state by cycling the hydrogen fuel in the cryo-compressed state from the storage system through the heat exchanger to an output.

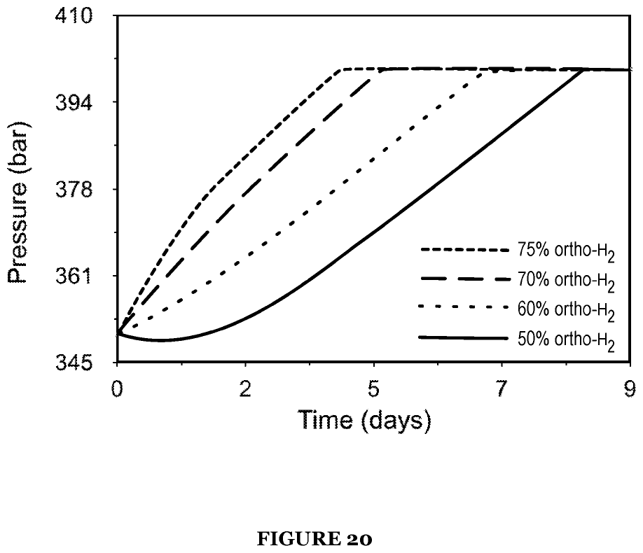

Dispensing the cryo-compressed hydrogen S300 may, in some variations include determining a type of cryo-compressed hydrogen utilization S302 as shown in FIG. 15. As shown in FIG. 20, the ortho-para ratio may be controlled to target different to improve cryo-compressed hydrogen dormancy, thereby avoiding venting. For example, tuning the ortho-concentration to 50% can double the dormancy relative to normal hydrogen.

Block S302, which includes determining a type of cryo-compressed hydrogen utilization, functions to determine at what rate the cryo-compressed hydrogen will be used as a fuel, and thereby an appropriately improved ortho-hydrogen threshold to dispense for utilization. Note that conversion, such as via catalyst, requires additional energy to compensate for the exothermic conversion. As a result, this method optimizes energy savings based on desired used case. For example, for use cases, where the cryo-compressed hydrogen will be immediately used, unmodified (or short term) cryo-compressed hydrogen may be allocated. For example, this may be the case for heavy construction vehicles that will directly use large quantities of fuel immediately following refueling. Alternatively, for use cases where the cryo-compressed hydrogen will be used slowly, or not used at all for some time, very low ortho-hydrogen threshold (or relatively long-term) may be allocated. For example, this may be the case for a truck that is refueled right before a holiday, and will not be operated for several days. As another example, a truck is fueled 1-2 days before it drives, due to refueling station constraints. In such a case, the additional energy required to ensure a low ortho-threshold, perhaps even equilibrium ortho-concentration, is justified.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

In one variation, a system comprising of one or more computer-readable mediums (e.g., non-transitory computer readable mediums) storing instructions that, when executed by the one or more computer processors, cause a computing platform to perform operations comprising those of the system or method described herein such as: Preparing a cryo-compressed hydrogen; maintaining the cryo-compressed hydrogen; and dispensing the cryo-compressed hydrogen.

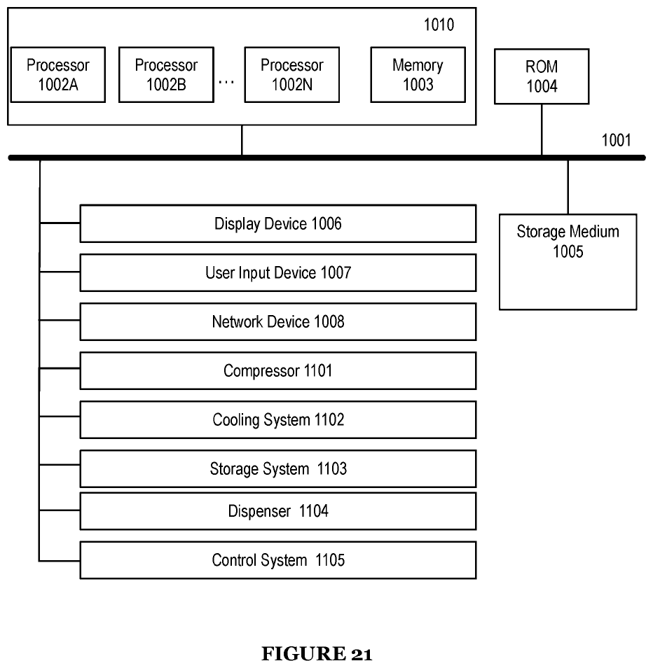

FIG. 21 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting a compressor 1101, a cooling system 1102, a storage system 1103, dispensing system 1104, a control system 1105, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A system for managing a cryo-compressed state of hydrogen fuel comprising:
a cooling system with an inlet for hydrogen fuel in a compressed state; and
a storage system wherein the storage system stores hydrogen fuel in a cryo-compressed state resulting from cooling of the hydrogen fuel by the cooling system.

2. The system of claim 1, further comprising a compressor with a gaseous hydrogen input and a compressor output that delivers hydrogen fuel in a compressed state; wherein the compressor output is coupled to the cooling system for transfer of the hydrogen in the compressed state to the cooling system.

3. The system of claim 2, wherein the compressor compresses a hydrogen fuel in a gaseous state to a compressed state with a pressure of 200-875 bar; and wherein the cooling system cools the hydrogen fuel in the compressed state to 33-100K thereby establishing cryo-compressed hydrogen.

4. The system of claim 2, further comprising a dispensing system coupled to the storage system.

5. The system of claim 4, further comprising a fuel processing network comprising interconnecting conduit channels that connect at least the compressor, cooling system, storage tank, and the dispenser in a sequential processing flow.

6. The system of claim 5, wherein the hydrogen fuel in the compressed state has an ortho concentration between 15 to 75%.

7. The system of claim 5, further comprising a catalyst.

8. The system of claim 7, wherein the fuel processing network comprises a catalyst conduit channel and a non-catalyst conduit channel.

9. The system of claim 7, wherein the cooling system comprises a heat exchanger and a refrigeration system, wherein the heat exchanger is thermally coupled to the refrigeration system, and wherein the hydrogen in the compressed state is passed through the heat exchanger.

10. The system of claim 9, wherein the catalyst is integrated within the heat exchanger.

11. The system of claim 9, wherein the refrigeration system is additionally thermally coupled to the storage vessel.

12. The system of claim 9, further comprising a reprocessing sub-network within the heat exchanger that comprises a first selectable conduit channel that transfers hydrogen fuel in the cryo-compressed state to the storage vessel and a second selectable conduit channel that recirculates the hydrogen fuel through the heat exchanger.

13. The system of claim 5, wherein the fuel processing network comprises a cooling system reprocessing subnetwork that selectably recycles hydrogen from the storage system back through the cooling system.

14. The system of claim 7, further comprising a control system and a ortho-para monitoring system that collects ortho-para concentration data from the hydrogen fuel in the cryo-compressed state; wherein the fuel processing network comprises a reprocessing sub-network, wherein the control system can cycle hydrogen fuel back to the catalyst through the reprocessing sub-network based on the ortho-para concentration data.

15. The system of claim 5, wherein the fuel processing network comprises a reprocessing loop that cycles vented gaseous hydrogen from the storage vessel to the compressor.

16. The system of claim 1, wherein the storage system comprises a plurality of storage tanks.

17. The system of claim 16, wherein a first storage tank and a second storage tank of the plurality of storage tanks store hydrogen of cryo-compressed hydrogen with differing ortho-para concentrations.

18. The system of claim 17, further comprising a dispensing system, wherein the dispensing system selectively dispenses from a select storage tank of the plurality of storage tanks based on ortho-para concentration of the select storage tank.

19. A method for managing cryo-compressed hydrogen comprising:
compressing hydrogen fuel in a gaseous state to a compressed state;
cooling the hydrogen in the compressed state to produce hydrogen fuel in a cryo-compressed state; and
storing the hydrogen fuel in the cryo-compressed state in a storage system.

20. The method of claim 19, further comprising dispensing the hydrogen in the cryo-compressed state.

21. The method of claim 19, wherein cooling the hydrogen in the compressed state comprises passing the hydrogen fuel in the compressed state through a heat exchanger and exposing the hydrogen fuel to a catalyst while within the heat exchanger.

22. The method of claim 21, further comprising measuring a temperature of the hydrogen fuel; and based on a temperature difference between the temperature and a reference temperature from similar processing conditions of the heat exchanger without a catalyst, recycling the hydrogen fuel back through the heat exchanger or storing the hydrogen fuel in a cryo-compressed state in a storage system.

23. The method of claim 19, further comprising dispensing the hydrogen in the cryo-compressed state by cycling the hydrogen fuel in the cryo-compressed state from the storage system through the heat exchanger to an output.

24. The method of claim 19, further comprising venting gaseous hydrogen from the storages system and recycling the gaseous hydrogen to a compressor for compressing and cooling the hydrogen back to the cryo-compressed state.

25. The method of claim 19, wherein storing the hydrogen fuel in the cryo-compressed state in the storage system comprises selectively transferring hydrogen in the cryo-compressed state to one of a set of storage vessels of a storage system based on ortho-concentration.
